(19) United States
(12) Patent Application Publication
(10) Pub. No.: US 2019/0075860 A1
(43) Pub. Date: Mar. 14, 2019

(54) PROTECTIVE TOP FOR WEIGHT TRAINING

(71) Applicant: Christiana Ukoli, Nashville, TN (US)

(72) Inventor: Christiana Ukoli, Nashville, TN (US)

(21) Appl. No.: 16/111,637

(22) Filed: Aug. 24, 2018

Related U.S. Application Data
(60) Provisional application No. 62/557,455, filed on Sep. 12, 2017.

(51) Int. Cl. A41D 13/05; A41D 27/28; A41D 31/00; A41C 3/08; A41D 13/015; A63B 71/12

(52) U.S. Cl. CPC A41D 13/0512; A41D 1/067; A41D 31/0016; A41C 3/08; A41D 31/005; A41D 31/0083; A41D 13/015; A41D 13/0518; A41D 13/0531; A63B 71/12; A63B 71/1291; A41D 2400/70; A41D 2300/322; A41D 2400/22; A41D 2400/62; A41D 2400/34; A41D 2600/10; A63B 2244/09; A41D 27/28

(57) ABSTRACT

A protective article of clothing for weight training comprising including a top adapted to be worn on an upper portion of an athlete. The top include a front surface and a rear surface, left and right arm openings and a head opening. An impact-resistant flexible collar is integrally attached to the top and is sized and positioned to substantially encircle the head opening. The collar is also configured to dampen an impact force to at least a portion of the athlete's shoulders, upper chest and upper back.

### CROSS-REFERENCE TO RELATED APPLICATION

This application claims the benefit of U.S. Provisional Patent Application No. 62/557,455, filed on Sep. 12, 2017 and entitled PROTECTIVE APPAREL FOR WEIGHT TRAINING, which is incorporated herein by reference in its entirety.

### FIELD OF THE INVENTION

The present invention relates generally to apparel and more particularly to tops and bottoms provided with protective features for guarding against injury to an athlete during weight training.

### BACKGROUND OF THE INVENTION

Due to the placement and movement of a weight during the progression of certain weight lifting exercises, athletes may sustain impacts, resulting in injury, abrasions or bruising, during the course of the lift when the weight contacts (e.g., brushes past, is supported by) a portion of their body. For example, FIG. 1 illustrates the typical stages of progression of a “clean and press” exercise. During the clean and press, a weighted barbell is lifted from the floor to a position over the athlete's head and is then returned to the floor. In the first (i.e., clean) phase of the lift, the weight is quickly lifted from the floor, past the shins, knees, thighs, and hips in a single motion. The weight comes to rest across the upper chest and shoulder area of the athlete momentarily to end the first phase of the lift. During the second (i.e., press) phase, the weight is lifted from the shoulders overhead in a single motion. Finally, to complete the lift, the motions are reversed and the weight is lowered back to the shoulders and then down the front of the body to the floor. While performing this lift, it is crucial that the weight remain as close to the athlete's body as possible in order to avoid injury and to maximize the effectiveness of the lift. It may be appreciated that, as a result of the proximity between the athlete's body and the weight during the exercise, the weight or weighted bar may contact the athlete's body in these zones of likely contact 100 (shins, knees, thighs, hips, hip creases, shoulders, and upper back) many times during each repetition. Each time this occurs, there is a potential for injury to the athlete.

Accordingly, what is needed is protective garments that protect athletes' bodies against injury during weightlifting exercises.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

### SUMMARY OF THE INVENTION

The above and other needs are met by a protective article of clothing for weight training. The article may be a bra top having an integrated bra portion, shirt having sleeves, a sleeveless shirt, etc. The protective article includes a top that is adapted to be worn on an upper portion of an athlete. The top has a front surface and a rear surface, left and right arm openings and a head opening. Importantly, an impact-resistant flexible collar is integrally attached to the top and is sized and positioned to substantially encircle the head opening. In certain embodiments, the impact-resistant flexible pad is continuous and extends from the front surface to the back surface of the garment.

The collar is configured to dampen an impact force to at least a portion of the athlete's shoulders, upper chest and upper back. In certain embodiments, the top is adapted to apply a compressive force to the athlete when worn. In some embodiments, the collar extends continuously around the entire head opening. In other embodiments, the collar extends discontinuously around the entire head opening. In those cases, a selectively closeable front opening may be located on the front surface of the garment for separating a left-front portion of the top and collar from a right-front portion of the top and collar for facilitating the removal the article. In preferred embodiments, the article includes a zipper for selectively closing the front opening.

In some embodiments, the top includes a cooling portion formed exclusively by a breathable mesh for enabling body heat to escape from within the top. The article may include an inner contact layer that is configured to directly contact the athlete. The inner contact layer may be formed from a moisture-wicking material. Additionally, the inner contact layer may be formed from an anti-bacterial material. In some embodiments, the inner contact layer is disposed between the collar and the athlete. In certain cases, the article also includes an outer layer that may be decorative or non-decorative. In those cases, the collar is preferably located between the inner contact layer and the outer layer. The collar is preferably sized and configured such that a portion located along the rear surface of the top extends vertically downwards from the head opening to a location proximate the bottom of the athlete's scapulae when the article is worn. Also preferably, the collar is sized and configured such that a portion located along the front surface of the top extends vertically downwards from the head opening to a location proximately co-linear with the top of the of the athlete's underarm when the article is worn. In some cases, an impact-resistant extended rear neck guard extends upwards from an upper rear portion of the collar. In preferred embodiments, the neck guard extends at least to the C7 vertebrae of the athlete.

In order to facilitate an understanding of the invention, the preferred embodiment of the invention, as well as the best mode known by the inventor for carrying out the invention, is illustrated in the drawings, and a detailed description thereof follows. It is not intended, however, that the invention be limited to the particular embodiment described or to use in connection with the apparatus illustrated herein. Therefore, the scope of the invention contemplated by the inventor includes all equivalents of the subject matter described herein, as well as various modifications and alternative embodiments such as would ordinarily occur to one skilled in the art to which the invention relates. The inventor expects skilled artisans to employ such variations as seem to them appropriate, including the practice of the invention otherwise than as specifically described herein. In addition, any combination of the elements and components of the invention described herein in any possible variation is encompassed by the invention, unless otherwise indicated herein or clearly excluded by context.

### BRIEF DESCRIPTION OF THE DRAWINGS

The presently preferred embodiments of the invention are illustrated in the accompanying drawings, in which like reference numerals represent like parts throughout, and in which:

FIG. 1 illustrates stages of progression of a typical clean and press exercise with zones of likely contact during the performance of the exercise being highlighted;

FIGS. 2 and 3 are front and a rear views, respectively, illustrating a protective article of clothing according to an embodiment of the present disclosure;

FIGS. 4 and 5 are front and rear views, respectively, depicting a protective top according to an embodiment of the present disclosure; and

FIG. 6 is a sectional view of a portion of a protective article of clothing according to an embodiment of the present disclosure depicting an impact force being applied to a padded area of the article of clothing;

FIGS. 7 and 8 are front and rear views, respectively, depicting bottoms according to an embodiment of the present disclosure.

### DESCRIPTION OF THE PREFERRED EMBODIMENTS OF THE INVENTION

This description of the preferred embodiments of the invention is intended to be read in connection with the accompanying drawings, which are to be considered part of the entire written description of this invention. The drawings are not necessarily to scale, and certain features of the invention may be shown exaggerated in scale or in somewhat schematic form in the interest of clarity and conciseness.

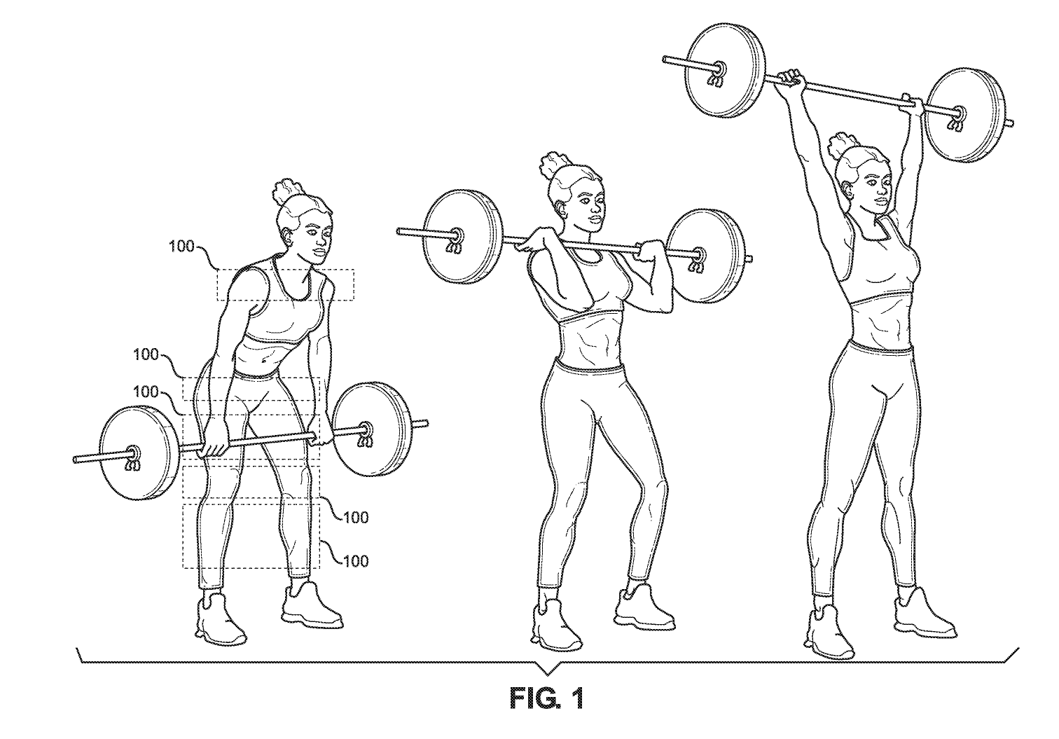

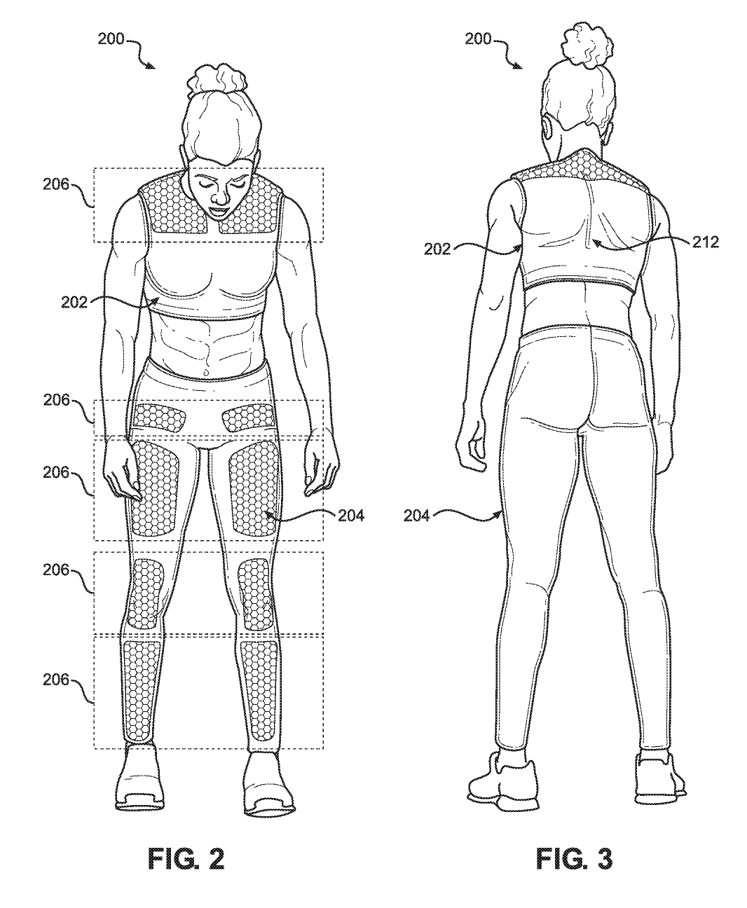

With reference now to FIGS. 2 and 3, there is provided a protective article of clothing 200 for athletes having a top 202 adapted to be worn on an upper portion of an athlete and bottoms 204 adapted to be worn on a bottom portion of the athlete. In this version, top 202 is a separate article of clothing from bottoms 204. However, a single article 200 that provides both top 202 and bottoms 204 (e.g., a unitard) is also contemplated. As discussed further below, article 200 is provided with protected areas 206 that are located in areas that preferably correspond to the zones of likely contact 100 shown in FIG. 1. The protected areas 206 help guard certain areas of the athlete's body, including include the shins, knees, thighs, hips, hip creases, upper chest, and front and rear shoulder areas, against injury while they are exercising, including particularly while performing weighted lifts such as squats, deadlifts, overhead press, etc.

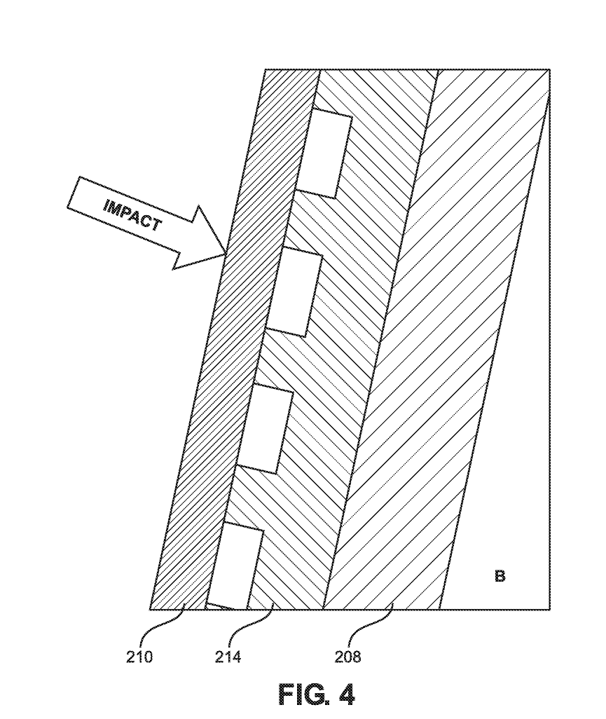

Referring to FIG. 4, the article 200 may include one or more additional layers that are joined together or, at least, stacked on one another. Since the article 200 is intended for use by athletes, it should enable free, unrestricted movement by the athlete. Additionally, article 200 preferably applies a compressive force to the athlete when worn to, among other things, increase oxygenated blood flow through the athlete's body. In this particular case, a majority of the article 200 is constructed of an inner contact layer 208 that is located immediately adjacent and directly contacts the athlete's body B when the article is worn. Preferably, one or more of the layers wicks away moisture from the athlete. Also, one or more of the layers is anti-microbial. In this particular case, the inner layer 208 (i.e., the layer of fabric adjacent the athlete's body) is made using a blend of materials, which may include cotton, nylon, polyester and spandex, such as SP-XP52, which is both moisture-wicking and anti-microbial. Because of its proximity to the athlete's skin, the inner layer 208 (e.g. SP-XP52) is preferably soft and comfortable. Preferably, the material gives and provides some degree of stretch to enable the athlete to move freely while wearing the garment. The wicking and anti-microbial properties of the inner layer keep the athlete dry and help to inhibit the growth of fungi.

For aesthetic or other purposes, one or more outer layers 210, which may be formed using the same material as the inner layer, may be placed outside of the inner layer 208 or may be used entirely separate from the inner layer 208. Certain areas of the article 200 may include only the inner layer 208, only an outer layer 210, or may directly expose the athlete's skin. In preferred embodiments, the article 200 includes a cooling portion 212 (FIG. 3) that is formed exclusively by a breathable outer layer (e.g., a nylon and spandex blend mesh) or that is an opening formed in the article that directly exposes the athlete's skin will allow the article 200 to breathe and for heat and moisture to be quickly and easily wicked away from the athlete.

The protective areas 206 of the article 200 are provided with protective padding layer 214 that is preferably formed as a middle layer interposed between the inner layer 208 and the outer layer(s) 210. The padding layer 214 protects the athlete from injury caused, for example, by weights brushing past or being placed onto the athlete's body. Accordingly, it is important that the padding layer 214 is sufficiently tough to withstand repeated frictional contact with weights that brush past it but is also sufficiently dense to provide support when weights are placed onto the protective areas 206. A suitable padding for this purpose is a foam, such as “XRD 810 series foam” provided by XRD®, which has a density between 10-20 lbs./ft³.

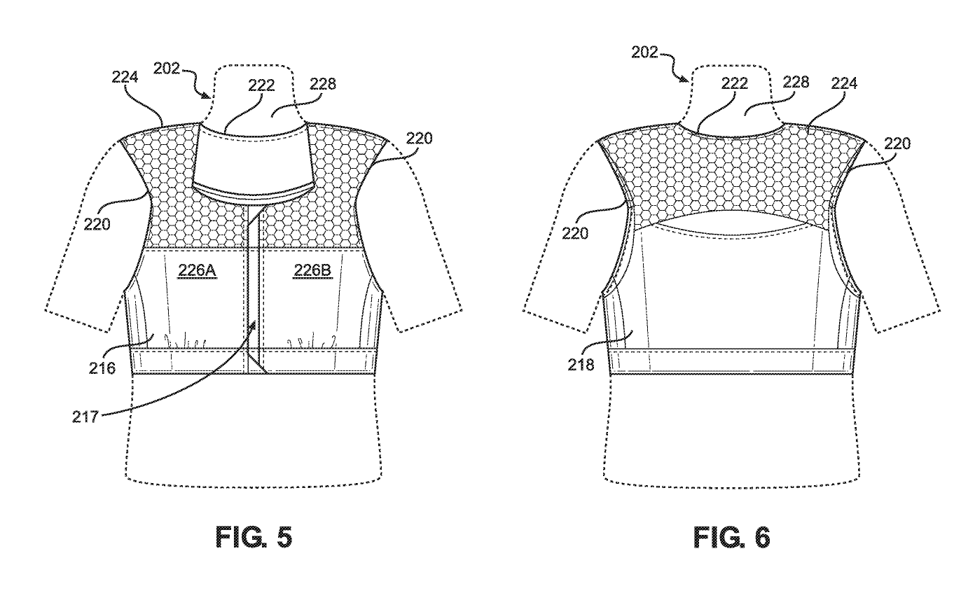

Another illustrative embodiment of a top 202 according to the present invention is depicted in FIGS. 5 and 6. The top 202 includes a front surface 216 and a rear surface 218, left and right arm openings 220 and a head opening 222. The top 202 may be a bra top having an integrated bra portion or it may be a sleeveless shirt or a short- or long sleeved shirt (sleeves and shirt tail shown in dashed lines). An impact-resistant flexible collar 224 is integrally attached to the top 202 and is sized and positioned to substantially encircle the head opening 222. The collar 224 preferably extends over the athlete's shoulders and partially down the athlete's chest and back. It is designed to protect athletes by dampening impact forces to an athlete's shoulders, upper chest and upper back as the athlete performs various weight training or other sports-related exercises.

In some embodiments, the collar 224 extends continuously around the entire head opening 222. When donning the top 202, an athlete would slip his or her head through the opening 222 and the collar 224 would surround the athlete's neck continuously. In other cases, the collar 224 is discontinuous such that one portion may be separated from another portion for easier donning and doffing of the top 202. Certain preferred embodiments have a selectively closeable front opening 217 located on the front surface 204 of the article 200. The front opening provides a first front portion 226A of the top 202 that is separable from a second front portion 226B of the top. In this case, the entire front surface 216 of the top 202 is divided by the front opening. However, in other embodiments, the front opening 217 divides only a portion of the front surface 216 (e.g., similar to a “quarter zip” sweater) and the top acts as a pullover. In either case, the front opening 217 assists a wear to more easily put the top on and take it off. A number of closures may be used for selectively closing the front opening 217. In this particular case, a zipper is provided for closing the front opening 217.

When correctly positioned, collar 224 surrounds the neck and shoulders of the athlete and is also configured to protect the upper chest area, including the clavicle and upper sternum. These are key areas that are prone to injury during many weight lifting exercises, including the clean and press exercise discussed above. In preferred embodiments, to protect the athlete's upper chest, a portion of the collar 224 located along the front surface 216 of the top 202 extends vertically downwards from the head opening 222 to a location approximately co-linear with the top of the of the athlete's underarm when the article is worn (i.e., just below the top of the sternum). In other embodiments, collar 224 extends even further down the front surface 216 of the top 202. Preferably, the padded collar 224 covers the bones and muscles located at the base of the neck and upper back (e.g., C7 vertebrae, upper trapezius, etc.). This is important for protecting the athlete against injury caused by exercises such as the back squat, where a weighted bar is supported by or is brought into contact with or proximate to the back. As such, a portion of the collar 224 located along the rear surface 218 of the top 202 extends vertically downwards from the head opening 222 to a location proximate the bottom of the athlete's scapulae when the article 200 is worn to protect the upper back of the athlete. In some cases, the collar 224 includes an integrated neck guard 228 that extends vertically upwards from the head opening 222 preferably to at least to the C7 vertebrae of the athlete.

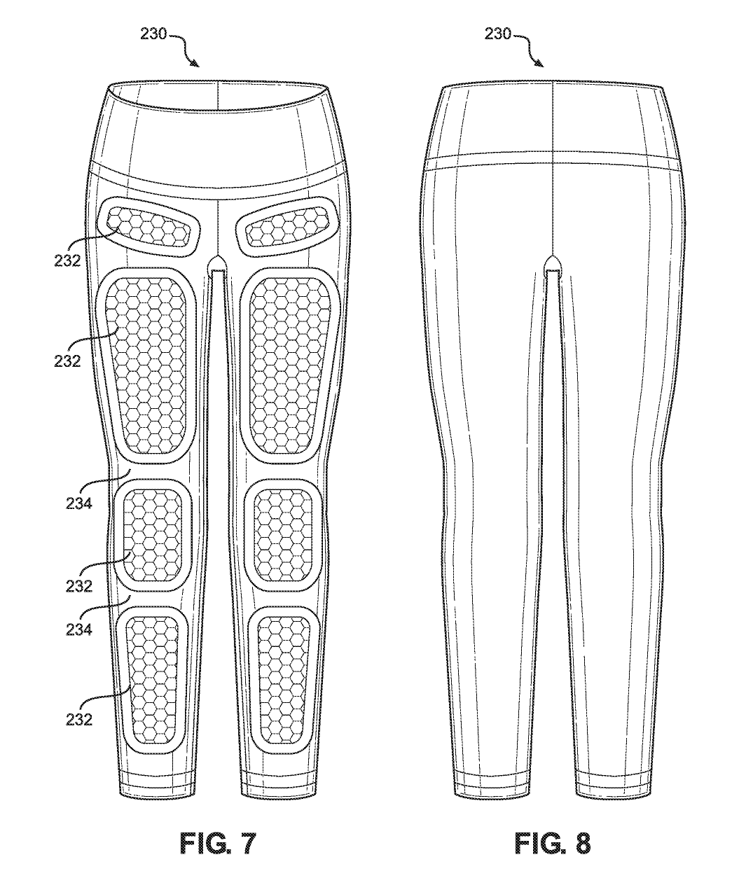

FIGS. 7 and 8 are front and back illustrations of protective bottoms 230 according to an embodiment of the present disclosure. Like the top 202 discussed above, the bottoms 230 are constructed primarily of an inner layer and, optionally, one or more outer layers that are joined together. Certain areas of the pants are provided with padded sections that are covered by flexible pads 232 in order to protect the athlete against injury. Specifically, padded sections are positioned to cover the athlete's shin, knee, thigh, and hip or a hip crease. Spaces 234 are provided between the pads 232 (i.e., above and below the knee) to enable the user to easily bend at the knee, waist, etc.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A protective article of clothing for contact sports comprising:
a top adapted to be worn on an upper portion of an athlete and having a front surface and a rear surface, left and right arm openings and a head opening;
an impact-resistant flexible collar integrally attached to the top and sized and positioned to substantially encircle the head opening and configured to dampen an impact force to at least a portion of the athlete's shoulders, upper chest and upper back.

2. The article of claim 1 wherein the top is adapted to apply a compressive force to the athlete when worn.

3. The article of claim 1 wherein the collar extends continuously around the entire head opening.

4. The article of claim 1 wherein the collar extends discontinuously around the entire head opening.

5. The article of claim 1 comprising a selectively closeable front opening located on the front surface of the garment for separating a left-front portion of the top and collar from a right-front portion of the top and collar for facilitating the removal the article.

6. The article of claim 5 further comprising a zipper for selectively closing the front opening.

7. The article of claim 1 wherein the top comprises a cooling portion formed exclusively by a breathable mesh for enabling body heat to escape from within the top.

8. The article of claim 1 further comprising an inner contact layer configured to directly contact the athlete.

9. The article of claim 2 wherein the inner contact layer is formed from a moisture-wicking material.

10. The article of claim 2 wherein the inner contact layer is formed from an anti-bacterial material.

11. The article of claim 2 wherein the inner contact layer is disposed between the collar and the athlete.

12. The article of claim 2 further comprising an outer layer, wherein the collar is located between the inner contact layer and the outer layer.

13. The article of claim 12 wherein the outer layer is decorative.

14. The article of claim 1 wherein the flexible collar is continuous and extends from the front surface to the back surface of the garment.

15. The article of claim 1 wherein the article is a bra top having an integrated bra portion.

16. The article of claim 1 wherein the article is a shirt having sleeves.

17. The article of claim 1 wherein the article is a sleeveless shirt.

18. The article of claim 1 wherein the collar is sized and configured such that a portion located along the rear surface of the top extends vertically downwards from the head opening to a location proximate the bottom of the athlete's scapulae when the article is worn.

19. The article of claim 1 wherein the collar is sized and configured such that a portion located along the front surface of the top extends vertically downwards from the head opening to a location proximately co-linear with the top of the of the athlete's underarm when the article is worn.

20. The article of claim 1 further comprising an impact-resistant extended rear neck guard extending upwards from an upper rear portion of the collar to at least the C7 vertebrae of the athlete.
